(19) United States
(12) Patent Application Publication
(10) Pub. No.: US 2025/0100333 A1
(43) Pub. Date: Mar. 27, 2025

(54) SYSTEM FOR ROPING PRACTICE

(71) Applicant: Dallon Sagers, Moroni, UT (US)

(72) Inventors: Dallon Sagers, Moroni, UT (US); Jesus Gonzalez, Washington, UT (US); Jacob Johnson, Hurricane, UT (US); Shawnee Sagers, Freedom, UT (US)

(73) Assignee: Dallon Sagers, Moroni, UT (US)

(21) Appl. No.: 18/893,354

(22) Filed: Sep. 23, 2024

Related U.S. Application Data
(60) Provisional application No. 63/584,976, filed on Sep. 25, 2023.

(51) Int. Cl. B60D 1/06; A63B 69/00; B60D 1/52; B60D 1/62

(52) U.S. Cl. CPC B60D 1/065; A63B 69/0068; B60D 1/52; B60D 1/62

(57) ABSTRACT

A system for roping practice includes a vehicle, a roping dummy, and a hitch device couplable between the vehicle and the roping dummy. A switch on or near a bumper of the vehicle is configured to stop the vehicle from moving, allowing for a riderless vehicle. When a user lassos and pulls against the roping dummy, the switch is actuated, thereby ceasing forward movement of the vehicle. Once the user is ready to lasso again, the user may initiate the drive mode of the vehicle once more. In some examples, the vehicle is autonomously driven using a navigation system and/or one or more transmitters positioned along the boundaries of a practice arena.

### CROSS-REFERENCE TO RELATED APPLICATIONS

This application claims the benefit of U.S. Provisional Application Ser. No. 63/584,976, filed on Sep. 25, 2023, which is incorporated herein by reference.

### TECHNICAL FIELD

The present disclosure relates to livestock roping dummies. In particular, the present disclosure relates to a hitch mechanism that enables an autonomously driven roping dummy used in practice for rodeos.

### BACKGROUND

Livestock roping is a skillset that traces its origins back to working cattle ranches of the Old West where horses, bulls, steers, calves, etc. were each roped to provide individual attention to the animal. While still used on ranches today, these roping techniques are also practiced in rodeo events such as tie-down roping, team roping, breakaway roping, and similar events. For example, tie-down roping, also known as calf roping, is a timed rodeo event where upon release from a chute, a calf is given a head start before a rider mounted on their horse is permitted to pursue. In order to lasso the calf, the rider throws a loop of a lariat around the calf's neck while at full gallop on the horse. The rider then dismounts from the horse, flips the calf onto its side and, once on the ground, ties three of the calf's legs together with a short rope, also called a “piggin' string.” Top professional ropers can rope and tie a calf in 7 seconds. Additional rodeo events and circumstances on a cattle ranch or open range require related roping skills.

There are many roping “dummies” available to practice roping skills without using actual livestock. Typically, these dummies are attached to an all-terrain vehicle (ATV) or utility terrain vehicle (UTV), or to a horse with a rider. In these embodiments, a second person is required to drive the ATV, UTV, or horse. The requirement of a second person to train, however, is an impediment to regular practice. Alternative systems involve attaching the dummies to a stationary pivot or track. While these systems can be used by the rider without a second person, they are overly simplistic and thus less comparable to actual, often erratic, livestock movements.

Accordingly, there is a need for a roping dummy that can be used without a second person and that provides a more faithful representation of a calf's movements. The system for roping practice disclosed herein solves these problems and others.

### SUMMARY OF EXAMPLE EMBODIMENTS

In some embodiments, a system for roping practice comprises a vehicle, a roping dummy, and a hitch device couplable between the vehicle and the roping dummy. In some embodiments, the hitch device may comprise a receiver tube couplable to a shaft, a pressure switch (e.g., electromechanical sensor or pressure contact), and a magnet positioned together on a bumper of the vehicle.

In some embodiments, the hitch device further comprises an extension spring that substantially surrounds a threaded rod, positioned along the first side of the receiver tube. A magnetic surface on a distal end of the threaded rod is placed in alignment with the pressure switch and magnet such that a circuit is closed whenever pressure measured on a surface of the pressure switch exceeds a predetermined threshold value. The circuit is opened whenever the pressure measured on the surface of the pressure switch falls below the predetermined threshold value.

In some embodiments, the hitch device comprises a linear actuator (e.g., mechanical cylinder, screw drive, etc.) positionable along the second side of the receiver tube opposite the extension spring. Upon a brief delay period after the pressure switch is disengaged and the circuit is opened, the linear actuator may be activated, thereby pushing the shaft farther within the receiver tube such that the magnetic surface on the threaded rod reestablishes contact with the pressure switch and magnet, again closing the circuit and preparing the vehicle to resume forward movement.

In some embodiments, the hitch device comprises a hitch body, a hitch mechanism slidable within the hitch body, a spring configured to apply force on the hitch mechanism, a switch actuatable via the hitch mechanism, and at least one controller for controlling a vehicle based upon the actuation of the switch.

The system for roping practice, in some embodiments, may comprise a vehicle control module (VCM) that enables a remote-control modality and/or autonomous driving capabilities of the vehicle. The VCM includes computer-executable instructions that enable the VCM by one or more processors executing the computer-executable instructions to selectively activate or deactivate any portion of the vehicle, such as its motors, steering, brakes, lighting systems/indicators, driving modes, etc.

In some embodiments, the system for roping practice comprises remote sensors that can be placed in four corners of a practice arena in order to establish boundaries for the vehicle when either remotely operated by the user or autonomously driven. The VCM may be configured to rely on the remote sensors to navigate the practice arena and establish driving routes.

### BRIEF DESCRIPTION OF THE DRAWINGS

FIG. 1 illustrates a right, side view of a system for roping;

FIG. 2 illustrates a top, left-side perspective view of a hitch device of a system for roping;

FIG. 3 illustrates a top, left-side perspective view of a hitch device of a system for roping in a loaded configuration;

FIG. 4 illustrates a top plan view of a hitch device of a system for roping in an unloaded configuration;

FIG. 5 illustrates a right, side view of a hitch device of a system of roping;

FIG. 6 illustrates a left, detailed perspective view of a hitch device of a system of roping;

FIG. 7 illustrates a right, bottom detailed view of a hitch device of a system of roping;

FIG. 8 illustrates a right, front, bottom perspective view of a hitch mechanism of a hitch device of a system of roping;

FIG. 9 illustrates a right, rear, bottom perspective view of a hitch body of a hitch device of a system of roping; and

FIG. 10 illustrates a right, side elevation cross-section of a hitch device of a system of roping.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

The term “calf” as used throughout this disclosure may refer to any young bovine animal or livestock more generally including, horses, bulls, steers, pigs, goats, cows, related cattle, etc.

As previously discussed, there is a need for a roping dummy that can be used without assistance from a second person and that renders an authentic representation of a calf's movements. The roping dummy would enable a user to practice by themself under circumstances closely approximating real life situations and/or rodeo conditions, thereby leading to faster improvement in their roping abilities. The present disclosure addresses these problems and others.

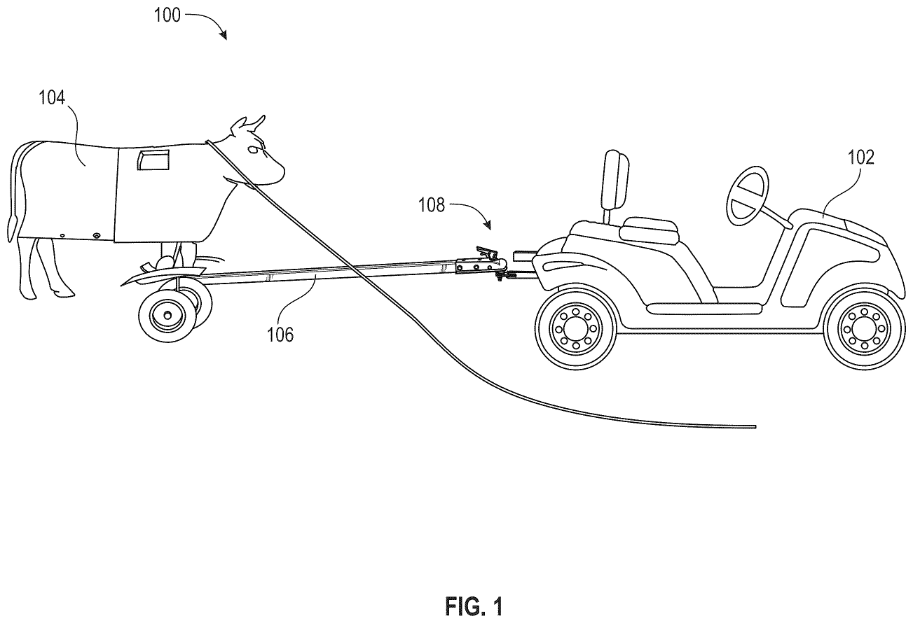

As illustrated in FIG. 1, in some embodiments, a system for roping practice 100 comprises a vehicle 102, a roping dummy 104, a tongue 106 extending from the roping dummy 104, and a hitch device 108 couplable between the vehicle 102 and tongue 106. The roping dummy 104 may comprise skis or mounted wheels so as to be maneuverable on terrain and to mimic realistic cornering and other movement.

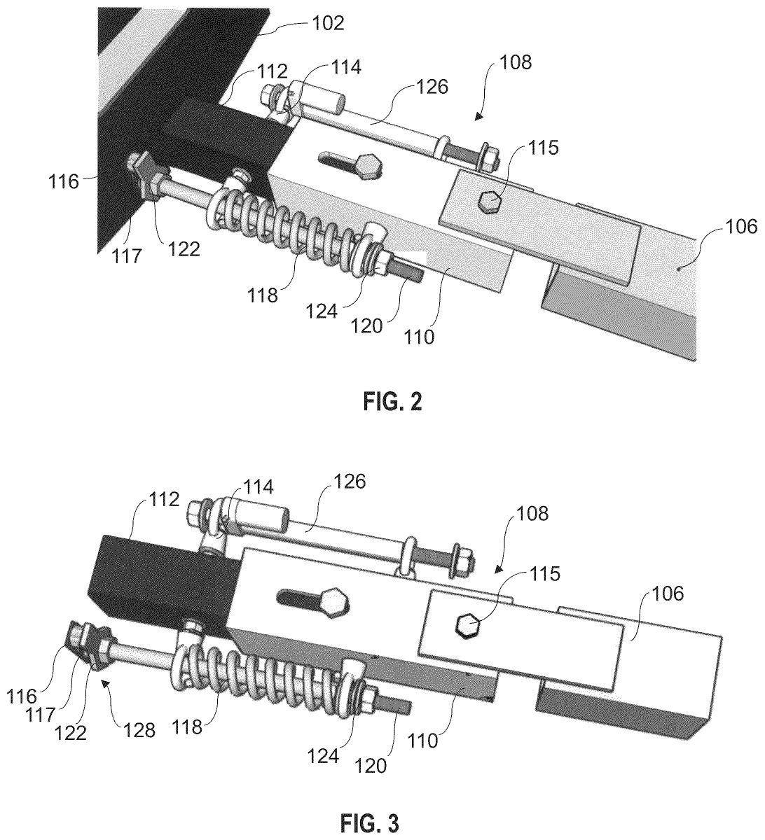

Referring to FIG. 2, the hitch device 108 comprises a receiver tube 110 couplable to a shaft 112. As shown, the receiver tube 110 may comprise four side walls, but may also be cylindrical or in any other shape capable of being telescopic in relation to the shaft 112. A hitch pin 114 may be used to secure the shaft 112 to the receiver tube 110 by threading the hitch pin 114 through an aperture on a first side of the receiver tube 110, through the shaft 112, and out an aperture on a second side of the receiver tube 110. The tongue 106 may be couplable to the receiver tube 110 via hitch pin 115. Although a receiver tube 110, shaft 112, and tongue 106 are described, it will be appreciated that a ball mount or other pivotable hitch assembly as known in the art may be used without departing from the teachings herein.

The hitch device 108, in some embodiments, comprises a pressure switch 116 (e.g., electromechanical sensor, pressure contact, magnetic switch, etc.) and a magnet 117 that may be positioned together, in some embodiments, on a bumper of the vehicle 102 couplable to the shaft 112. The hitch device 108, in some embodiments, though without limitation, may further comprise an extension spring 118 that substantially surrounds a threaded rod 120, positioned along the first side of the receiver tube 110. A magnetic surface 122 on a distal end of the threaded rod 120 is placed in alignment with the pressure switch 116 and the magnet 117 such that a circuit is closed whenever pressure measured on a surface of the pressure switch 116 exceeds a predetermined threshold value. The magnet 117 may produce a magnetic field that attracts the magnetic surface 122 which may comprise metals such as iron, nickel, cobalt, etc., or another magnet with an opposite pole to the magnet 117. This magnetic interaction promotes adherence between the magnetic surface 122 and the adjacent pressure switch 116. The circuit may be opened whenever the magnet 117 and the magnetic surface 122 become decoupled and/or the pressure measured on the surface of the pressure switch 116 falls below the predetermined threshold value. While a default setting of the pressure switch 116 is described as a normally closed switch, the pressure switch 116 could also be a normally open switch, wherein the functionality of the switch is reversed.

While the magnet 117, magnetic surface 122, and pressure switch 116 may be operable without the extension spring 118, the extension spring 118 is configured to further act as an adjustable pressure setting to control the force of contact between the magnet 117 and the magnetic surface 122. A user may thereby tighten or loosen the extension spring 118 via a nut 124, wing nut, thumb screw, or alternative fastener to control a degree of compression of the extension spring 118. The tighter the nut 124 is fastened to the extension spring 118, the more compressed the extension spring 118 becomes and the more pressure is required to disengage the magnetic surface 122 on the threaded rod 120 from the pressure switch 116 and magnet 117. Relatedly, the looser the nut 124 is fastened to the extension spring 118, the less compressed the extension spring 118 is and the less pressure is required to disengage the magnetic surface 122 on the threaded rod 120 from the pressure switch 116 and magnet 117.

The hitch device 108 further comprises a linear actuator 126 (e.g., mechanical cylinder, screw drive, etc.) that, in some embodiments, is positionable along the second side of the receiver tube 110 opposite the extension spring 118. The linear actuator 126 may comprise a motor, a gear box, and a lead screw configured to actuate a rod or piston forwards and backwards. Upon a brief delay period after the pressure switch 116 is disengaged and the circuit is opened, the linear actuator 126 may be activated, thereby pushing the shaft 112 farther within the receiver tube 110. Accordingly, the magnetic surface 122 on the threaded rod 120 reestablishes contact with the pressure switch 116, again closing the circuit and preparing the vehicle 102 to resume forward movement.

As depicted in FIG. 3, the system for roping practice 100 comprises a loaded configuration 128, wherein the magnetic surface 122 on the threaded rod 120 is in substantial contact with the pressure switch 116 and the magnet 117, such that the circuit is closed, enabling the vehicle 102 to move forward when directed by a user. As the vehicle 102 moves forward, the user then attempts to lasso the roping dummy 104 being pulled by the vehicle 102. The user may lasso the roping dummy 104 by the neck, heel, horns, etc. depending on the event. When successfully lassoed, resistance and drag from the force of the user pulling against the forward momentum of the roping dummy 104 causes the magnetic surface 122 on the threaded rod 120 to disengage from the pressure switch 116 and the magnet 117. As described above, the amount of pressure required to be exerted can be adjusted by tightening or loosening the nut 124 accordingly against the extension spring 118.

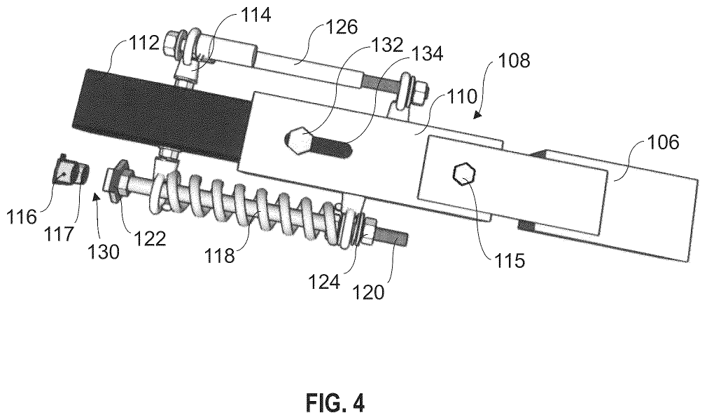

As depicted in FIG. 4, the circuit within the hitch device 108 is opened, creating a gap or break between the pressure switch 116 and the magnetic surface 122 that disrupts the flow of current through the circuit. This open-circuit state is also referred to as an unloaded configuration 130. Transition from the loaded configuration 128 to the unloaded configuration 130 and accompanying shift between the closed circuit and the open circuit acts as an engine cut-off switch mechanism that causes the vehicle 102 to cease forward movement and come to a complete stop. It will be appreciated that this sequence of events mimics the behavior of a calf during roping events. With the vehicle 102 stopped, the user may remove the lasso from the roping dummy 104, take time to evaluate the user's performance, and then reset his or her position to resume practicing. It will be appreciated that a retaining bolt 132 in a slot 134 may allow the receiver tube 110 to slide on the shaft 112 without being removed therefrom and ensuring that pressure can be reapplied to the pressure switch 116 without damaging it.

The linear actuator 126 may then be activated, causing the shaft 112 to be inserted farther within the receiver tube 110, thereby reestablishing contact between the magnetic surface 122 and the pressure switch 116 and the magnet 117. With contact reestablished, the vehicle 102 can resume forward movement. The total duration of time between the circuit returning to the loaded configuration 128 from the unloaded configuration 130 may be selected by the user (e.g., 10 seconds, 30 seconds, 1 minute, etc.) or otherwise be predetermined as a default setting of the system for roping practice 100.

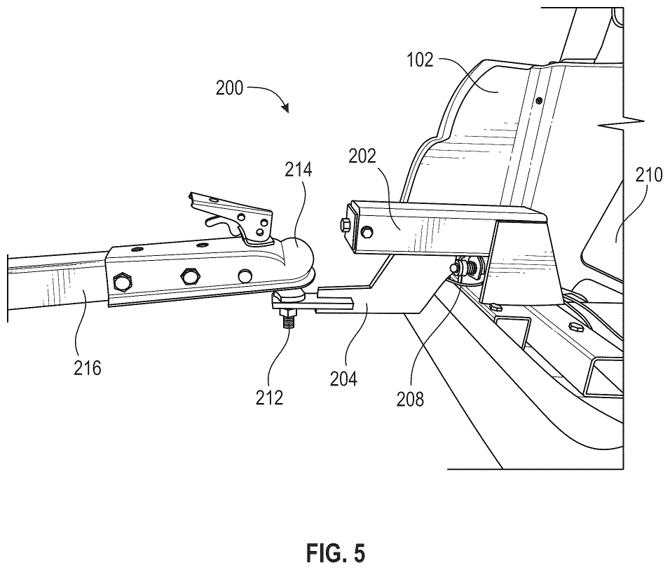

Referring now to FIGS. 5-10, in some embodiments, the hitch device 200 comprises a hitch body 202, a hitch mechanism 204 slidable within the hitch body 202, a spring 206 configured to apply force on the hitch mechanism 204, a switch 208 actuatable via the hitch mechanism 204, and at least one controller 210 (e.g., vehicle control module) for controlling the vehicle 102, including on/off state, drive state, etc., based upon the actuation of the switch 208. As shown in FIG. 5, the hitch mechanism 204 may comprise, or otherwise be coupled to, a ball 212, the ball 212 couplable to a ball receiver 214 and tongue 216 coupled to a dummy 104 (FIG. 1).

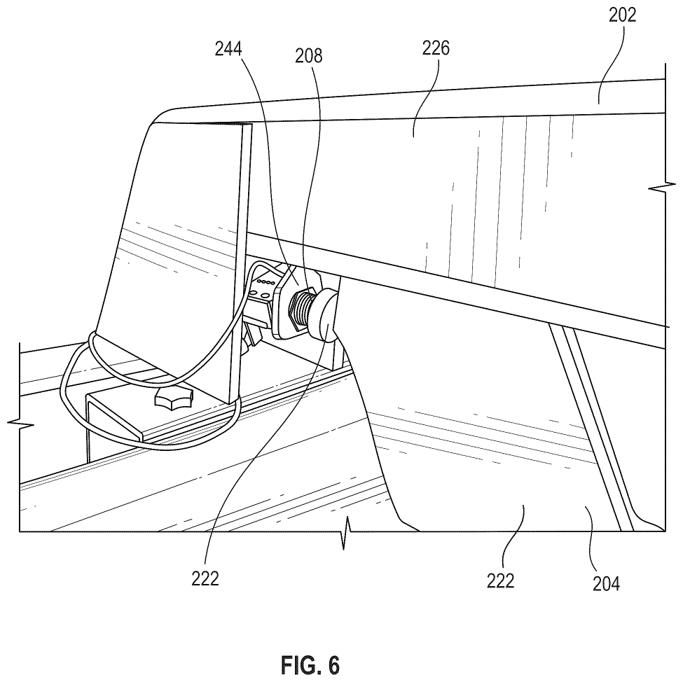

FIG. 6 illustrates a detailed view of the hitch body 202, hitch mechanism 204, and the switch 208. As shown, the hitch mechanism 204 is in contact with the switch 208 and is configured to thereby actuate the switch 208. As will be understood, because the hitch mechanism 204 is slidable within the hitch body 202 (explained in greater detail later herein), the switch 208 may be actuated by the hitch mechanism changing its contact with the switch 208. The switch 208 may be a button switch, pressure switch, contact switch, or any other type of switch capable of being physically actuated by the movement of the hitch mechanism 204.

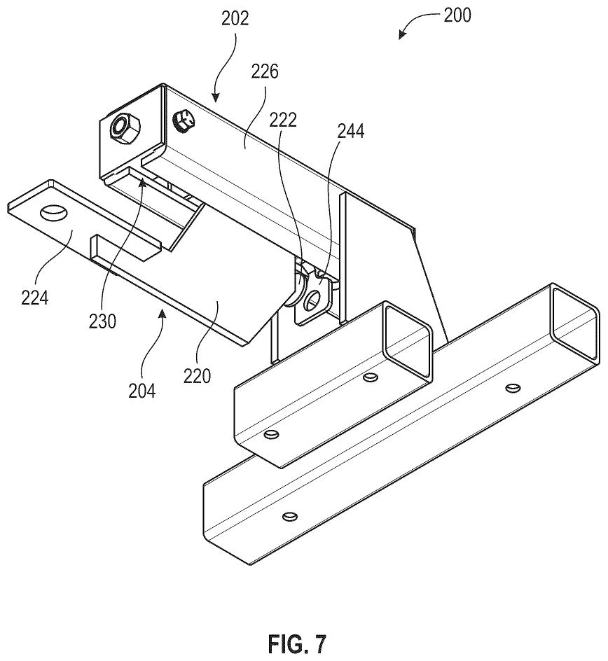

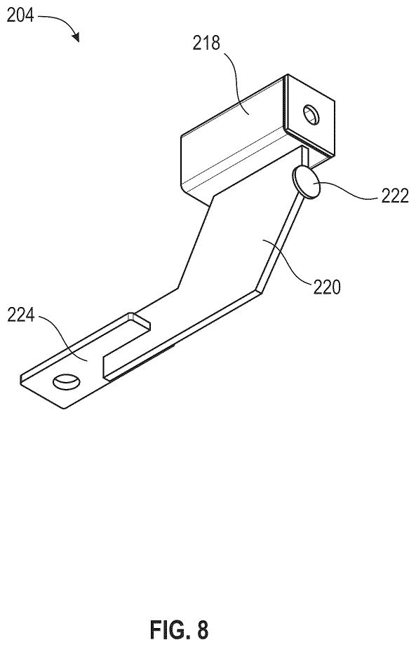

FIGS. 7-10 illustrate the hitch device 200 and components that make up its assembly. Referring to FIG. 8, the hitch mechanism 204 comprises a first member 218 configured to be received within the hitch body 202, a second member 220 extending vertically downward from the first member 218, the second member 220 comprising a contact plate 222 for contacting the switch 208. The second member 220 further comprises a ball receiving bracket 224. As shown, the first member 218 may be cuboidal, but such a shape is not required and other configurations may be used (e.g., cylindrical) without departing herefrom.

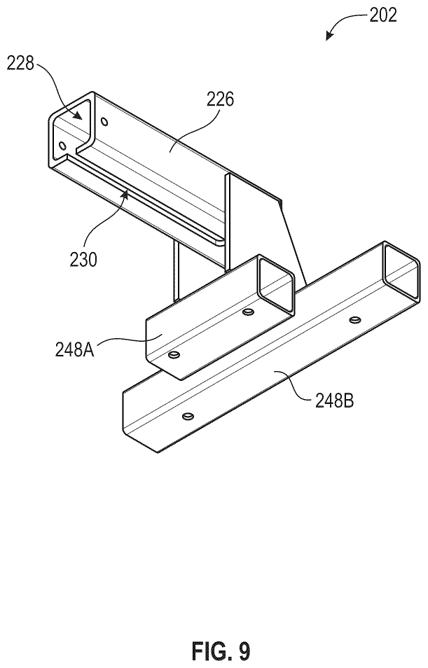

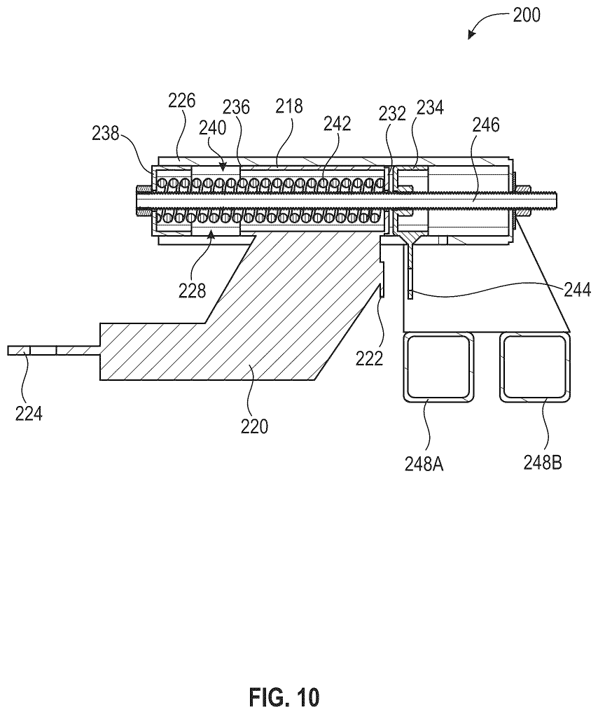

Referring to FIG. 9, the hitch body 202 comprises a receiving member 226 having a hollow shaft 228 therein, the receiving member 226 comprising a channel 230 configured to allow the second member 220 of the hitch mechanism 204 to pass therethrough and slide therein. In other words, and perhaps as best shown in the cross-section of FIG. 10, the first member 218 of the hitch mechanism 204 is received and slidable within the hollow shaft 228 of the receiving member 226. A first end 232 of the first member 218 is proximal to a switch bracket 234. A second end 236 of the first member 218 is capped by an end bracket 238, the end bracket 238 prohibiting the first member 218 from exiting the hollow shaft 228. A gap 240 between the end bracket 238 and the second end 236 of the first member 218 allows the first member 218 to slide within the hollow shaft 228 (e.g., telescopic). A coil spring 242 forces the first member 218 toward the switch bracket 234, where the contact plate 222 can remain in contact with the switch 208 (not shown in FIG. 10, but as shown in FIG. 6) supported by a vertical member 244 of the switch bracket 234. In some embodiments, bushings or bearings may be interposed between the first member 218 and the receiving member 226 to allow easier sliding. However, such bushings/bearings are not required.

Because the contact plate 222 remains in contact with the switch 208 due to the spring 242, a circuit remains closed, allowing the vehicle 102 to remain powered on and drivable. When a user lassos the dummy 104 coupled to the hitch mechanism 204, the dummy 104 is pulled rearwardly from the vehicle 202 (since the vehicle is driving forward). This rearward force causes the first member 218 to compress the spring 242 and close the gap 240, thereby relieving the pressure of the contact plate 222 on the switch 208, opening the circuit and cutting power to the drive mechanism of the vehicle 102 or cutting the overall power to the vehicle 102. When a user releases the tension on the lasso, the spring 242 extends, thereby reestablishing contact between the contact plate 222 and the switch 208. With contact reestablished, the vehicle 202 is ready to start and/or drive once again once initiated by the user.

As shown, a threaded bolt 246 passes through the end bracket 238, through the spring 242, through the first member 218, through the switch bracket 234, and through the receiving member 226, thereby maintaining the assembly of the components. The bolt 246 may be positioned so as to vary the pressure of the spring 242, thereby determining how much rearward force must be applied to disengage the contact plate 222 from the switch 208. Alternately, the spring 242 may be changed by a user based to one with more or less tension, depending on the desires of the user.

As shown, the hitch body 202 may comprise one or more frame members 248A-B for added structural integrity. However, such frame members 248A-B are not required.

The controller 210 may be, or comprise, a vehicle control module (VCM) that enables a remote-control modality and/or autonomous driving capabilities of the vehicle 102. The VCM may comprise one or more controllers (e.g., microcontrollers), a transceiver, and a user input/output interface (e.g., screens, buttons, lights, etc.), which may allow the user to control and receive information regarding driving behavior of the vehicle 102, and which facilitates communication between the vehicle 102 and a remote-control device during use. For example, the user input/output interface may be on the controller 210 directly and may comprise a touch screen, buttons, switches, etc., or may be a software application that is configured to launch on a smartphone, tablet, or computer using wireless protocols (e.g., Bluetooth®, Wi-Fi, etc.). The user interface may comprise numerous indicators, including connection GPS indicators, state of charge indicators, state of switch 208, etc. The indicators may be lights or readouts. In addition, the user may adjust or set functions, such as setting an automatic start/stop point, a preselected route, a preselected driving behavior corresponding to the roping skillset being practiced, among other features.

In its most basic configuration, the controller 210 includes at least one hardware processing unit (also known as a “processor”), input/output (I/O) interfaces, and storage. The storage may be physical system memory, which may be volatile, non-volatile, or some combination of the two. The term “memory” may also be used herein to refer to non-volatile mass storage such as physical storage media. If the controller is distributed, the processing, memory, and/or storage capability may be distributed as well. As used herein, the term “executable module,” “executable component,” or even “component” can refer to software objects, routines, or methods that may be executed on the controller (e.g., as separate threads).

Computer storage media are hardware storage devices, such as RAM, ROM, EEPROM, CD-ROM, solid state drives (SSDs) that are based on RAM, flash memory, phase-change memory (PCM), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

The disclosed embodiments may comprise or utilize a special-purpose or general-purpose computer including computer hardware, such as, for example, one or more processors (such as the hardware processing unit, which may include one or more central processing units (CPUs), graphics processing units (GPUs) or other processing units) and system memory (such as storage).

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code.

While not all computing systems require the user interface, in some embodiments, the controller 210 includes, as part of the I/O interfaces, the user interface for use in communicating information to/from the user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, buttons, cameras, keyboards, stylus, mouse, or other pointer input, sensors of any type, and so forth. The controller 210 may perform certain functions in response to detecting certain user input.

Further, the controller 210 may also include communication channels allowing the controller 210 to be in wireless (e.g., Bluetooth®, Wi-Fi®, satellite, infrared, etc.) communication with remote systems/devices. Remote systems/devices may be configured to perform any of the processing described with regard to the controller 210. In some embodiments, the controller 210 includes computer-executable instructions (e.g., stored on storage) that enable the controller 210 (e.g., by one or more processors executing the computer-executable instructions) to selectively activate or deactivate any portion of the vehicle 102, such as its motors, steering, brakes, lighting systems/indicators, driving modes, etc.

In some embodiments, the controller 210 may be configured to autonomously control one or more of the following systems: a powertrain control module, a transmission control module, a brake control module, a central control module, a central timing module, a general electronic module, and/or a suspension control module, thereby enabling an automatic drive system. The vehicle 102, in some embodiments, may further comprise four-wheel drive or offroad wheels or tracks configured to maneuver over uneven terrain, a global positioning system (GPS) module, and one or more front and rear sensors configured to further support autonomous driving. The one or more front and rear sensors may comprise infrared photocells, radar, LiDAR, ultrasonic sensors, camera-based optical vision, or other alternative means to autonomously navigate around the ground that are in communication with the controller 210. In some embodiments, the vehicle 102 may be operative using an internal combustion engine or an electric powertrain and battery using a DC voltage system.

In some embodiments, the system for roping practice comprises remote sensors (e.g., transmitters) that can be placed in four corners of a practice arena in order to establish boundaries for the vehicle 102 when either remotely operated by the user or autonomously driven. The controller 210 may be configured to rely on the remote sensors to navigate the practice arena and establish driving routes. Once driven, the coordinates of these driving routes may be stored within the memory of the controller 210 for later selection by the user during further practice sessions. The user may also indicate remote start and stop points along the driving routes that approximate a calf's start and stop points during rodeo events. This customization enables the development of muscle memory corresponding to the practice routines that can be reliably recreated during rodeo events for improved performance. It will be appreciated that the remote-control modality and/or autonomous driving capabilities enable the user to practice without assistance from another person. This is an advantage over traditional roping dummies pulled by an ATV that require two people to practice.

In some embodiments, the controller 210 may obtain readings from various sensors/chips (e.g., magnetometer, GPS module, proximity sensor, IR sensor, etc.) so as to determine the position, speed, and heading of the vehicle 102. In some embodiments, the system for roping practice 100 may comprise a local positioning system (LPS) using radio frequency (RF) to determine relative position, speed, heading, etc. LPS determine the precise location within a defined area by measuring signal strength, time of flight, or angle of arrival from multiple fixed reference points, enabling accurate triangulation. RF-based LPS are particularly useful in indoor environments where GPS signals are weak or unavailable, providing high-precision, real-time tracking, which is useful in enclosed arena practices. Controlling the vehicle 102 based on the readings by the various sensors/chips/LPS/etc. may be accomplished using software. In some embodiments, the controller 210 may utilize proportional-integral-derivatives (PID), hardcoding, full state feedback, or other methods when interpreting readings and executing instructions to thereby control the vehicle 102. In some embodiments, a user may customize vehicle routes, speed, engine-cutoff times based on the switch 208, among other features.

In some methods of use, a user would couple the dummy 104 to the vehicle 102 for roping practice. In a default state (due to spring 242), the contact plate 222 is in contact with the switch 208, closing a circuit. With the circuit closed, the vehicle may started and placed into drive. Depending on the configuration, the vehicle may turn at pre-programmed intervals or may turn based upon one or more signals (e.g., proximity sensors, GPS signals, LPS signals, etc.) received and processed by the controller 210. As a result, the vehicle 210 begins driving without the need of a person on the vehicle 102 to operate it. A user may then pursue the dummy 104 with a lasso. Once the user successfully lassos the dummy 104, the contact plate 222 is decoupled from the switch 208, thereby opening the circuit and cutting the power to the vehicle 102, thereby stopping the vehicle 102 to allow the user to reset. It will be appreciated that cutting power to the vehicle 102 is not required, and other methods, such as disengaging a transmission, applying brakes, or other methods may be utilized to stop the vehicle from moving forward.

Once stopped, the contact plate 222 once again contacts the switch 208, thereby closing the circuit once again. While described as contacting the switch 208, it will be appreciated that contactless methods, such as magnetic fields, may also be used to close the circuit. With the circuit closed, the vehicle 102 is ready to be initiated by a user to begin moving once again. In some embodiments, the vehicle 102 may be controlled, such as via the controller 210, to automatically restart moving after a predetermined time. In other words, once the vehicle is stopped, a user may remove the lasso and get ready to pursue once again (such as by mounting a horse), with the vehicle automatically starting and/or commencing to drive forward when the set time expires (e.g., 45 seconds). In some embodiments, a user may initiate the vehicle driving using input on the vehicle 102 itself or using a remote or smartphone application. As such, a user may easily practice roping without the need of a second person.

Accordingly, the system for roping, as described herein, overcomes the issues in the prior art by providing a roping dummy that enables a user to practice by themself under circumstances closely approximating real life situations and/or rodeo conditions, thereby leading to faster improvement in their roping abilities.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A system for roping practice, comprising:
a vehicle, comprising:
a controller configured to control the on/off state of the vehicle based on a status of a switch,
a dummy coupled to the vehicle via a hitch device;
wherein the hitch device is configured to actuate the switch.

2. The system of claim 1, wherein the hitch device comprises a hitch body and a hitch mechanism, the hitch mechanism configured to slide within the hitch body and actuate the switch.

3. The system of claim 2, wherein the hitch body comprises a receiving member configured to receive a first member of the hitch mechanism, the first member configured to be slidable within the receiving member.

4. The system of claim 3, wherein the receiving member comprises a switch bracket configured to secure the switch.

5. The system of claim 3, wherein the hitch mechanism comprises a second member having a contact plate configured to abut the switch.

6. The system of claim 5, wherein the second member is configured to slide in relation to the switch to thereby actuate the switch.

7. The system of claim 6, wherein a spring is configured to apply force to the first member to thereby keep the second member in contact with the switch.

8. The system of claim 7, wherein the spring is selectively compressible by a user to thereby disengage the second member from the switch.

9. The system of claim 8, wherein when the second member is disengaged from the switch, the controller stops the vehicle.

10. A system for roping practice, comprising:
a vehicle, comprising:
a controller configured to control the on/off state of the vehicle based on a status of a switch, and
a hitch device comprising:
a hitch body having a receiving member, the receiving member having a hollow shaft,
a switch bracket receivable within the hollow shaft and configured to hold the switch,
a hitch mechanism comprising a first member slidable within the hollow shaft, the first member having a first end proximal to the switch bracket,
a gap interposed between a second end of the first member and an end bracket,
a spring extending through the end bracket and the first member, biasing the first member in a first direction,
a threaded bolt extending through the end bracket, the spring, the first member, the switch bracket, and the receiving member,
a second member extending downwardly from the first member and passing through a channel, the second member comprising a ball receiving bracket;
a dummy comprising a tongue configured to couple to the hitch device via a ball coupled to the ball receiving bracket;
wherein when a user applies a rearward force to the dummy, the first member compresses the spring, allowing the first and second member to slide rearward in relation to the hitch body, thereby disengaging the second member from the switch, wherein the vehicle is configured to stop when the switch is disengaged.

11. A method of using a system for roping practice, the method comprising:
coupling a dummy to a vehicle;
initiating a drive mechanism of the vehicle and allowing the vehicle to operate without a human operator;
pursuing and lassoing the dummy;
wherein lassoing the dummy exerts a rearward force on the dummy in relation to the vehicle; and
wherein the rearward force on the dummy actuates a switch, the switch configured to cause the vehicle to stop moving.

12. The method of claim 11, wherein once the vehicle stops, the switch is actuated a second time, resetting the switch to a default, drive position.

13. The method of claim 11, wherein the dummy is coupled to the vehicle via a hitch device, the hitch device comprising a hitch body and a hitch mechanism.

14. The method of claim 13, wherein the hitch mechanism is slidable in relation to the hitch body.

15. The method of claim 14, wherein when rearward force is applied by the user, the hitch mechanism slides rearward in relation to the hitch body, thereby actuating the switch.

16. The method of claim 11, wherein the vehicle is configured to drive within a predetermined area.

17. The method of claim 16, wherein the vehicle comprises a controller configured to determine one or more of:
a. an on/off state of the vehicle;
b. a speed of the vehicle; and
c. a direction of the vehicle.

18. The method of claim 17, wherein one or more sensors are configured to provide information to the controller.
